(19) United States
(12) Patent Application Publication
(10) Pub. No.: US 2026/0186342 A1
(43) Pub. Date: Jul. 2, 2026

(54) BACKLIGHT MODULE AND DISPLAY DEVICE

(71) Applicant: Radiant Opto-Electronics Corporation, KAOHSIUNG (TW)

(72) Inventors: Yi-Shan LIN, KAOHSIUNG (TW); Yun-Ju CHU, KAOHSIUNG (TW); Chun-Hsien LI, KAOHSIUNG (TW); Po-Chun TSAI, KAOHSIUNG (TW); Hsien-Hsiang CHANG, KAOHSIUNG (TW)

(73) Assignee: Radiant Opto-Electronics Corporation, KAOHSIUNG (TW)

(21) Appl. No.: 19/411,887

(22) Filed: Dec. 8, 2025

(30) Foreign Application Priority Data
Jan. 2, 2025 (CN) 202520002288.X

(51) Int. Cl. G02F 1/13357

(52) U.S. Cl. CPC G02F 1/133606; G02F 1/133603; G02F 1/133608

(57) ABSTRACT

A backlight module, comprising a back frame, a light source, a diffusion plate, and a sleeve. The diffusion plate is disposed on the back frame and positioned on a light-emitting side of the light source. The sleeve is disposed on the back frame and extends along its axis through the light board and the diffusion plate. The diffusion plate has a plurality of printed dots, defining a blank region for the sleeve to pass through and a first region surrounding the blank region. The first region comprises a high-density area and a low-density area, the blank region being free of printed dots, and a distribution density of the printed dots in the high-density area being greater than the average distribution density of the printed dots in the low-density area. By designing different distribution densities of the printed dots, bright halos caused by the sleeve are overcome, thereby improving the light uniformity and optical quality of the overall light-emitting surface. The invention further provides a display device comprising the backlight module.

### RELATED APPLICATIONS

This application claims priority to China Application Serial Number 202520002288.X, filed on Jan. 2, 2025. The entire disclosures of all the above applications are hereby incorporated by reference.

### FIELD OF THE INVENTION

The present invention relates to an optical element, particularly referring to a backlight module and display device capable of enhancing light uniformity and optical quality.

### BACKGROUND OF THE INVENTION

Driver distraction and fatigue are major causes of vehicle accidents. A Driver Monitoring System (DMS) can serve as an additional layer of safety for driving. By installing a camera on the dashboard, the DMS collects facial movement features of the driver, such as blinking, gaze direction, and head movements, to monitor and detect the driver's behavior and physiological state. When abnormal data is detected, the system issues warning signals and activates driver assistance systems, thereby enhancing driving safety and reducing the risk of accidents.

When the camera is installed on the dashboard, how to balance the camera's field of view with the optical quality of the dashboard is a critical goal that industry professionals are striving to achieve.

### SUMMARY OF THE INVENTION

One object of the present invention is to provide a backlight module capable of enhancing light uniformity and optical quality.

The backlight module comprises a back frame, a light source, a diffusion plate, and a sleeve. The light source comprises a light board disposed on the back frame, and a plurality of light-emitting elements disposed on the light board. The diffusion plate is disposed on the back frame and located on a light-emitting side of the light source. The sleeve is disposed on the back frame, and the sleeve axially penetrates through the light board and the diffusion plate. Wherein, a surface of the diffusion plate is provided with a plurality of printed dots, defining the diffusion plate as having a blank region through which the sleeve passes, and a first region surrounding the blank region. The first region comprises at least one high-density region and one low-density region, the blank region being free of printed dots, a distribution density of the printed dots in the low-density region gradually decreasing in a direction from near the blank region toward away from the blank region, and a distribution density of the printed dots in the at least one high-density region being greater than an average distribution density of the printed dots in the low-density region.

In a preferable embodiment, the light source comprises a first light region and a second light region in which the light-emitting elements are arranged with different intervals, the light-emitting elements in the first light region being arranged at a first interval in an equidistant manner, and the light-emitting elements in the second light region being arranged at a second interval in an equidistant manner, the first interval is greater than the second interval, and the second light region corresponds to the at least one high-density region of the diffusion plate.

In a preferable embodiment, the diffusion plate further defines a second region surrounding the first region, and no printed dots are formed in the second region.

In a preferable embodiment, the back frame comprises a bottom plate portion and a surrounding portion disposed around a periphery of the bottom plate portion, and the sleeve is disposed on the bottom plate portion and extends unidirectionally away from the bottom plate portion.

In a preferable embodiment, the back frame comprises a bottom plate portion and a surrounding portion disposed around a periphery of the bottom plate portion, and the sleeve is disposed on the bottom plate portion and extends bidirectionally away from the bottom plate portion.

In a preferable embodiment, an outer surface of the sleeve has a reflectance at least 92%.

In a preferable embodiment, the printed dots are disposed on a light-incident surface of the diffusion plate, the light-incident surface facing the light board.

In a preferable embodiment, the sleeve is formed with an internal thread.

In a preferable embodiment, the backlight module further comprises a shading member disposed on the sleeve.

In a preferable embodiment, the backlight module further comprises a shading member fitted over the sleeve. The shading member comprises a ring portion disposed on the sleeve, a top edge portion extending radially inward from the ring portion and abutting a top edge of the sleeve, and a pressing portion extending radially outward from the ring portion, and the ring portion abuts an outer peripheral surface of the sleeve.

In a preferable embodiment, the backlight module further comprises a shading member fitted over the sleeve. The shading member comprises a ring portion disposed on the sleeve, a top edge portion extending radially outward from the ring portion, and a pressing portion extending from the top edge portion, wherein the ring portion abuts an inner peripheral surface of the sleeve, and an end edge of the sleeve is covered collectively by the ring portion, the top edge portion, and the pressing portion.

In a preferable embodiment, the backlight module further comprises at least one optical film disposed between the diffusion plate and the shading member, wherein the at least one optical film has a through-hole corresponding to the sleeve.

Another object of the present invention is to provide a display device which comprises the backlight module as described above, and a display panel arranged on the backlight module.

Another object of the present invention is to provide a display device which comprises the backlight module as described above, and a display panel arranged on the backlight module. Wherein, the display panel rests on the shading member.

The characteristic of the present invention is that, by designing the printed dots on the diffusion plate with different distribution densities, light passing through the high-density area can reduce the light output, overcoming bright halos caused by the sleeve, and thereby improving the light uniformity and optical quality of the overall light-emitting surface.

### BRIEF DESCRIPTION OF THE DRAWINGS

FIG. 1 is an exploded perspective view of a preferred embodiment of the backlight module of the present invention.

FIG. 2 is a schematic diagram illustrating the printed dot distribution of a diffusion plate.

FIG. 3 is a schematic diagram, being an enlarged view of the framed portion in FIG. 1, illustrating that light-emitting elements in different regions have different spacings.

FIG. 4 is a schematic diagram illustrating the positional relationship between the printed dot distribution of the diffusion plate and the light-emitting elements of different densities.

FIG. 5 is a partially enlarged view illustrating the structure of the sleeve.

FIG. 6 is a partially enlarged view illustrating another form of the sleeve.

FIG. 7 is a partially enlarged view of a preferred embodiment of a display device of the present invention.

FIG. 8 is a partially enlarged view illustrating a second form of the shading member.

### DETAILED DESCRIPTION OF THE INVENTION

The detailed description and preferred embodiments of the invention will be set forth in the following content and provided for people skilled in the art to understand the characteristics of the invention.

In the following description, the terms “about,” “substantially,” “approximately,” or “same” generally indicate a range within 10, 5%, 3%, 2%, 1%, or 0.5% of a given value. The quantities provided herein are approximate, such that even in the absence of specific reference to “about,” “substantially,” “approximately,” or “same,” these terms may still be implicitly understood to apply.

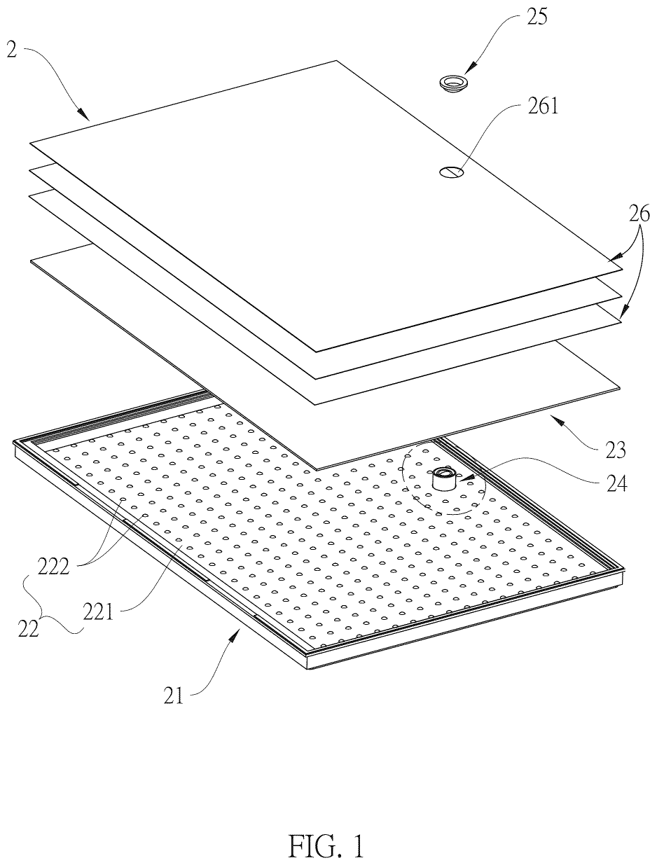

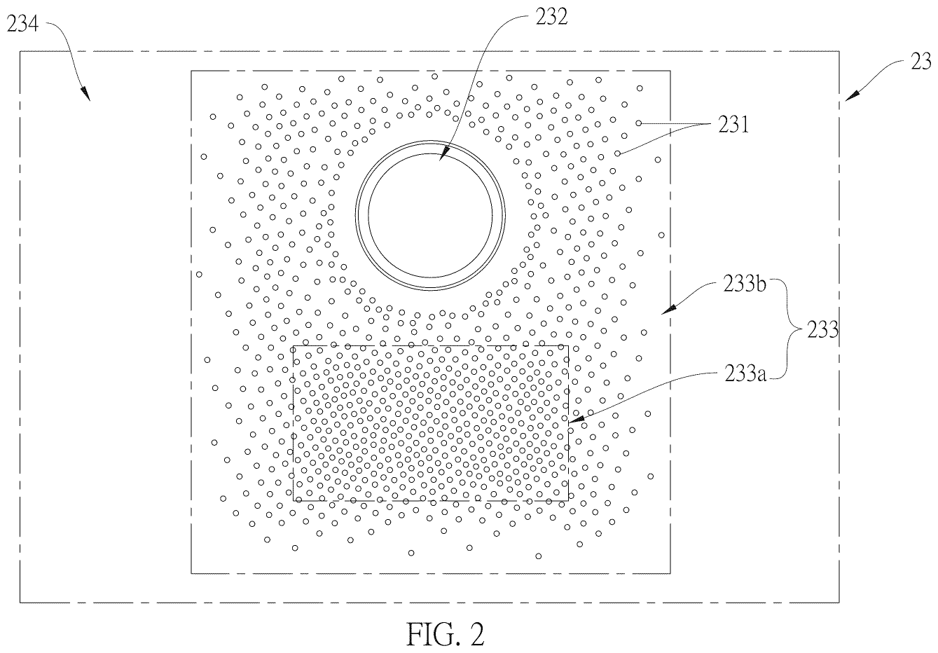

Referring to FIG. 1, it is a preferred embodiment of the backlight module of the present invention. The backlight module comprises a back frame 21, a light source 22, a diffusion plate 23, and a sleeve 24. The light source 22 includes a light board 221 disposed on the back frame 21, and a plurality of light-emitting elements 222 arranged on the light board 221. The diffusion plate 23 is disposed on the back frame 21 and located on a light-emitting side of the light source 22. The sleeve 24 is disposed on the back frame 21 and axially extends through both the light board 221 and the diffusion plate 23. Referring to FIG. 2, a partial region of the diffusion plate 23 adjacent to the sleeve 24 (see FIG. 1) is illustrated. The surface of the diffusion plate 23 is provided with a plurality of printed dots 231, thereby defining the diffusion plate 23 as having a blank region 232 for the insertion of the sleeve 24, and a first region 233 surrounding the blank region 232. The first region 233 includes at least one high-density region 233a and one low-density region 233b. No printed dots 231 are formed within the blank region 232. The distribution density of the printed dots 231 in the low-density region 233b decreases in a direction extending away from the blank region 232. The distribution density of the printed dots 231 in the high-density region 233a is greater than an average distribution density of the low-density region 233b. By means of the design in which the printed dots 231 on the diffusion plate 23 have different distribution densities, light passing through the high-density region 233a can have its light output reduced, thereby mitigating the halo effect caused by the presence of the sleeve 24. Moreover, through the distribution trend of the printed dots 231 in the low-density region 233b, a diffusion (frosted) effect is produced on the light-emitting surface near the sleeve 24, thereby enhancing the overall light-emitting uniformity and optical quality of the emitting surface.

It is to be noted that, in the present embodiment, the backlight module 2 is applied to a Driver Monitoring System (DMS) of a vehicle and is therefore typically installed at the instrument panel. The sleeve 24 is configured for mounting a camera lens. In order to prevent the camera lens from being obstructed or interfered with by a steering wheel, the position of the sleeve 24 is offset upward rather than being located at the center of the overall structure. The position of the sleeve 24 may be varied depending on actual application environments and is not limited thereto. The following description will detail the specific structural configuration of this embodiment.

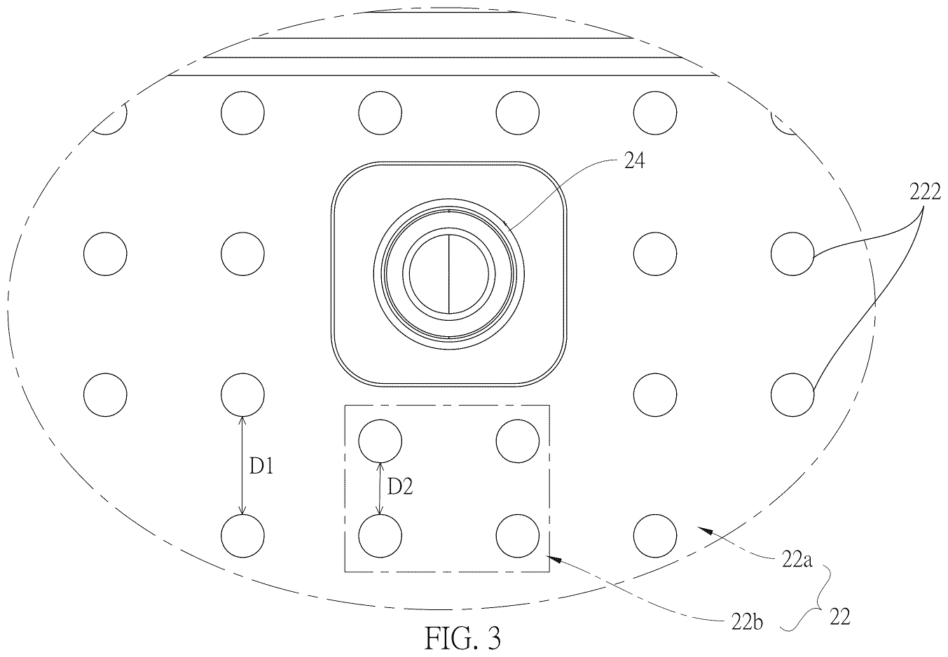

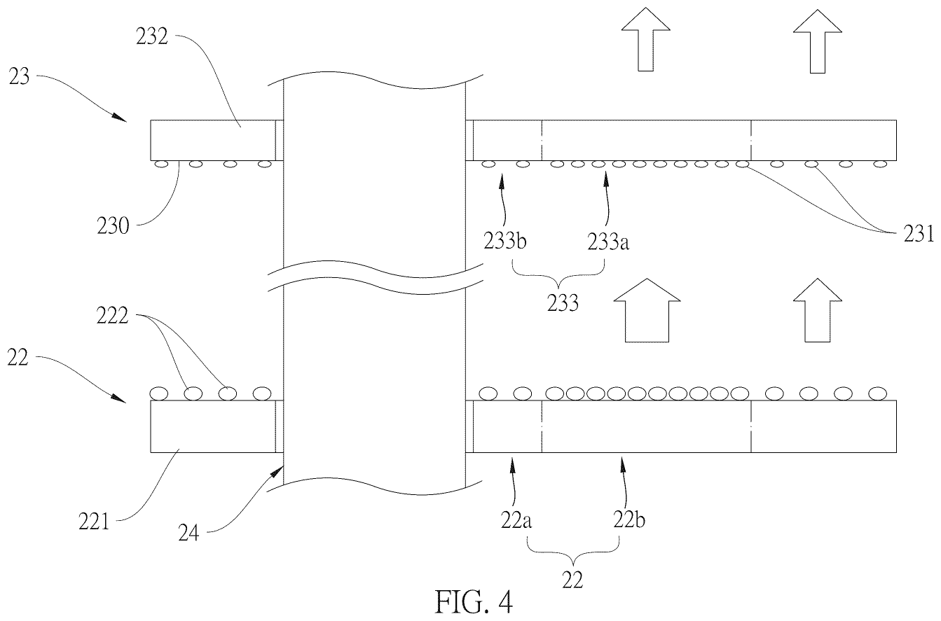

Referring to FIG. 3, which is an enlarged view of the region framed in FIG. 1, the light source 22 includes a first light region 22a and a second light region 22b, in which the light-emitting elements 222 are arranged with different spacings. The light-emitting elements 222 in the first light region 22a are uniformly arranged at a first pitch D1, while those in the second light region 22b are uniformly arranged at a second pitch D2. The first pitch D1 is greater than the second pitch D2, meaning that the light-emitting elements 222 in the second light region 22b are arranged at a higher density. More specifically, the second light region 22b corresponds to a region located adjacent to the sleeve 24. When comparing the number of light-emitting elements 222 per unit area of the light board 221, the number of light-emitting elements 222 per unit area in the vicinity of the sleeve 24 is smaller than that in the central region of the overall structure. As a result, the luminance near the sleeve 24 is slightly lower than that of the central region. Therefore, a higher-density arrangement of the light-emitting elements 222 may be employed in the second light region 22b to compensate for brightness. However, since light emitted from the densely arranged light-emitting elements 222 in the second light region 22b tends to cause a halo effect in a specific area, the high-density region 233a of the diffusion plate 23 is designed to correspond to the second light region 22b, as illustrated in FIG. 4. In this manner, the light emitted from the second light region 22b can be diffused (or scattered) by the high-density region 233a, such that the combination of the light source 22 and the diffusion plate 23 enhances the overall light-emitting uniformity of the backlight module. More specifically, as shown in FIG. 4, the width of the arrows represents the light output. Since the second light region 22b has a higher arrangement density of light-emitting elements 222, the light output is greater, represented by wider arrows, whereas the first light region 22a has a lower arrangement density, resulting in less emitted light and narrower arrows. Through the variation in the distribution density of the printed dots 231 between the high-density region 233a and the low-density region 233b of the diffusion plate 23, the light quantity after passing through the diffusion plate 23 can be adjusted to uniformity, thereby improving the light-emitting uniformity of the entire backlight module.

Concurrently, to enhance the brightness in the vicinity of the sleeve 24, the outer surface of the sleeve 24 may also be of a color with a reflectance at least 92% (in this embodiment, the outer surface of the sleeve 24 is white), allowing light to be reused through the reflective effect of its outer surface. When the reflection of light by the sleeve 24 causes the adjacent light-emitting surface to become excessively bright, a condition particularly pronounced when the outer surface of the sleeve 24 is white, the distribution trend of the printed dots 231 in the low-density region 233b can be utilized to create a diffusing (frosted) effect on the light-emitting surface near the sleeve 24. Furthermore, as light passes through the high-density region 233a, the amount of emitted light can be reduced (as indicated by the narrower arrow width shown in FIG. 4), thereby overcome the halo effect caused by the provision of the sleeve 24 and improving uniformity of the light-emitting surface of the overall backlight module.

Referring to FIG. 2, the diffusion plate 23 is defined to further have a second region 234 surrounding the first region 233. As there is no need to adjust light brightness in the second region 234, it is free of the printed dots 231. It should be particularly noted that the first region 233 of the diffusion plate 23 of the present invention is the portion that surrounds the blank region 232 and includes the printed dots 231. In some embodiments, the distribution of the printed dots 231 may extend from the blank region 232 to the outer edge of the diffusion plate 23. However, in the present embodiment, the second region 234, which is free of printed dots, surrounds the first region 233 and is adjacent to the outer periphery of the low-density region 233b. In other words, the printed dots 231 of the low-density region 233b are distributed only up to the boundary between the first region 233 and the second region 234, and do not extend to the outer edge of the diffusion plate 23.

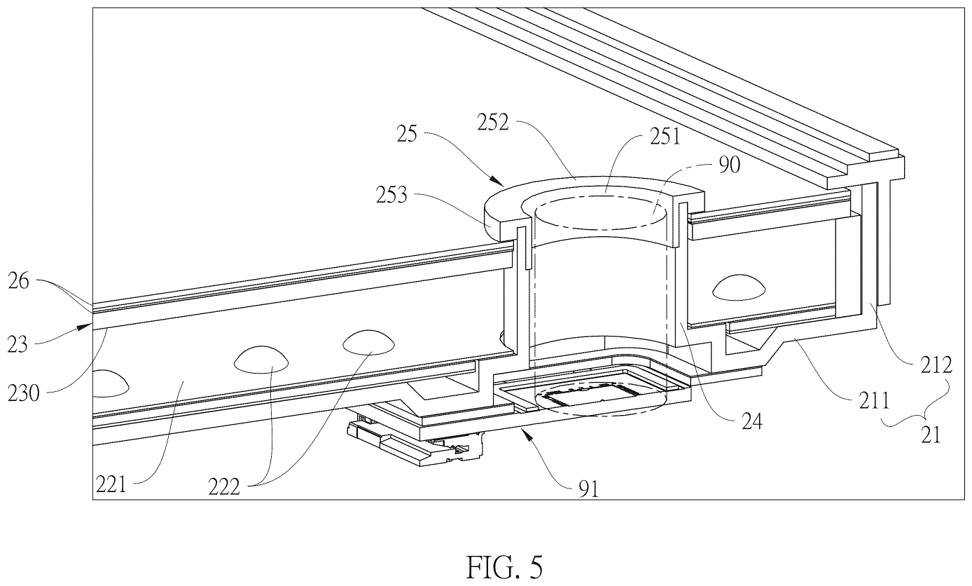

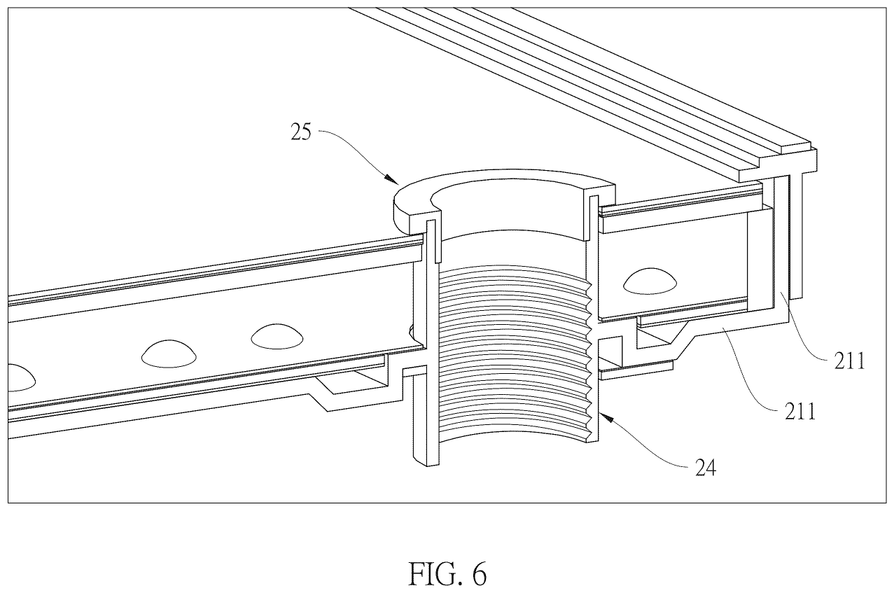

Referring to FIG. 2 and FIG. 5, the printed dots 231 are disposed on a light-incident surface 230 of the diffusion plate 23, and the light-incident surface 230 faces toward the light board 221. By arranging the printed dot 231 on the light-incident surface 230, friction between the printed dots 231 and other optical films after assembly can be avoided. As shown in FIG. 5, the back frame 21 includes a bottom plate portion 211 and a surrounding portion 212 disposed around the periphery of the bottom plate portion 211. The sleeve 24 is disposed on the bottom plate portion 211. In some embodiments, the sleeve 24 extends unidirectionally away from the bottom plate portion 211. The unidirectionally extending sleeve 24 may serve as a structural component for securing the diffusion plate 23 and other optical films. The sleeve 24 may be formed integrally with the bottom plate portion 211 by punching the bottom plate portion 211 directly, or alternatively, the sleeve 24 may be pre-formed and then riveted onto the bottom plate portion 211. In other embodiments, as shown in FIG. 6, the sleeve 24 extends bidirectionally away from the bottom plate portion 211. In practical applications, the form of the sleeve 24 may be selected according to the type of camera lens 90 or the installation environment of the backlight module 2. As illustrated in FIG. 5, the camera lens 90 may be disposed inside the sleeve 24 and secured therein by means of another retaining element 91. Alternatively, as shown in FIG. 6, the sleeve 24 may be formed with an internal thread, allowing the camera lens 90 (not shown in the figure) to be threadedly engaged with the sleeve 24, thereby simplifying the assembly process.

As shown in FIG. 5, the backlight module 2 further includes a shielding member 25 disposed on the sleeve 24, and a plurality of optical films 26. The optical films 26 are disposed between the diffusion plate 23 and the shielding member 25, and each of the optical films 26 defines a through hole 261 for fitting over the sleeve 24. The shielding member 25 includes a ring portion 251 sleeved on the sleeve 24, a top edge portion 252 extending radially outward from the ring portion 251, and a pressing portion 253 extending from the top edge portion 252. The ring portion 251 abuts the inner peripheral surface of the sleeve 24, and the end edge of the sleeve 24 is covered by the ring portion 251, the top edge portion 252, and the pressing portion 253. The provision of the shielding member 25 not only serves to secure the optical films 26 and the diffusion plate 23, but also blocks the gaps between the sleeve 24 and the diffusion plate 23 as well as the optical films 26, thereby preventing light from the light-emitting elements 222 from leaking through the gaps.

Referring to FIG. 2 and FIG. 3, when the light emitted from the light-emitting elements 222 passes through the diffusion plate 23, the printed dots 231 located on the light-incident surface of the diffusion plate 23 can reduce the amount of light passing therethrough. Accordingly, the diffusion plate 23 is provided with printed dots 231 at a higher density (i.e., the high-density region 233a) in locations corresponding to a greater number of light-emitting elements 222, namely the second light region 22b (or where the amount of transmitted light is larger), and at a lower density (i.e., the low-density region 233b) in locations corresponding to a smaller number of light-emitting elements 222, namely the first light region 22a (or where the amount of transmitted light is smaller). In this manner, the overall uniformity of light passing through the diffusion plate 23 can be improved. In addition, as shown in FIG. 4, the provision of the shielding member 25 prevents light from the light-emitting elements 222 from leaking through the gaps between the optical films 26 and the sleeve 24, or between the diffusion plate 23 and the sleeve 24. Meanwhile, the pressing portion 253 of the shielding member 25 serves to position and press the optical films 26 and the diffusion plate 23, thereby preventing displacement of the optical films 26 or the diffusion plate 23 and enhancing the structural stability of the overall assembly. In the present embodiment, the shielding member 25 is made of an elastic material (for example, rubber) and can be directly sleeved onto and tightened around the sleeve 24 for ease of assembly.

Referring to FIG. 6, a display panel 3 is disposed on the backlight module 2, thereby forming the display device of the present invention. In this configuration, in addition to being supported by a plastic frame 27, the display panel 3 can also rest on the shielding member 25, thereby preventing the display panel 3 from directly impacting the sleeve 24 and protecting the display panel 3.

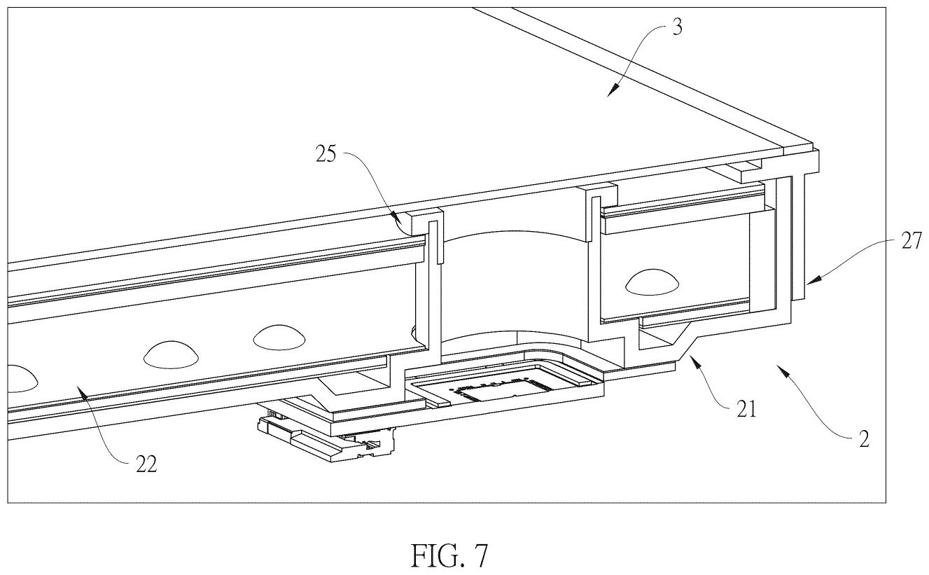

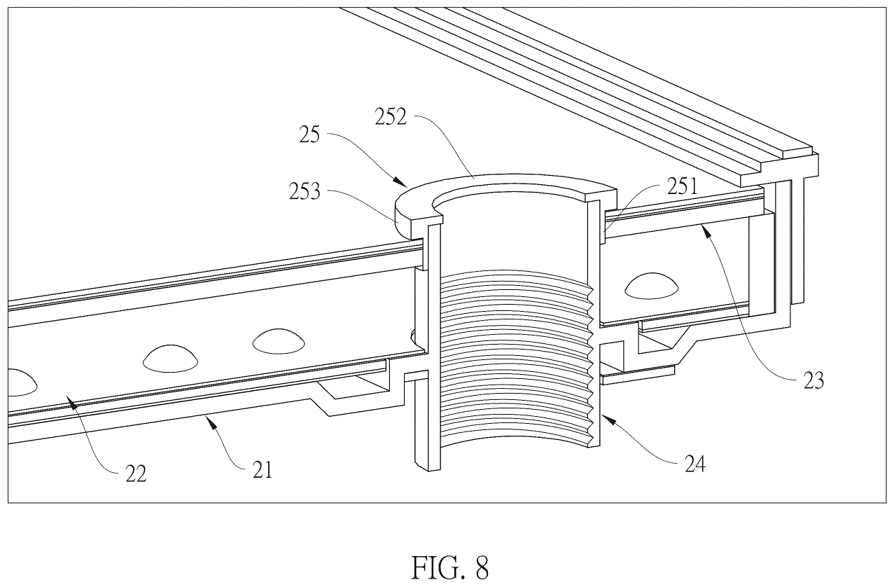

In certain embodiments, the configuration of the shielding member 25 may vary. As shown in FIG. 7, the shielding member 25 includes a ring portion 251 sleeved on the sleeve 24, a top edge portion 252 extending radially inward from the ring portion 251 and abutting the top edge of the sleeve 24, and a pressing portion 253 extending radially outward from the ring portion 251. The ring portion 251 abuts the outer peripheral surface of the sleeve 24. Alternatively, as shown in FIG. 8, the shielding member 25 is a single-ring structure fixed to the top edge of the sleeve 24 with adhesive tape. Furthermore, since a camera 90 or other sensing module is disposed inside the sleeve 24, in embodiments where the ring portion 251abuts the inner peripheral surface of the sleeve 24 (e.g., as shown in FIG. 5) it can prevent the camera 90 from directly impacting the sleeve 24, thereby protecting the camera 90.

The present invention utilizes the printed dots 231 on the diffusion plate 23 with different distribution densities. For example, the high-density region 233a, having a higher dot density than other regions, suppresses the excessively bright area near the sleeve 24. Concurrently, the dot distribution in the low-density region 233b creates a diffusing effect on the adjacent light-emitting surface, thereby suppressing the halo effect around the sleeve 24. This improves light uniformity in the vicinity of the sleeve 24 and enhances the overall optical performance of the backlight module's emitting surface. Furthermore, the shielding member 25 on the sleeve 24 prevents light leakage and improves the light uniformity across the entire emitting surface of the backlight module 2. This, in turn, enhances the emitting surface quality and allows for a reduction in the designed width of the display panel's black edge region (Black Matrix, BM). Moreover, the shielding member 25 is made of an elastic material and can be press-fit for easy assembly, which reduces assembly cost, shortens assembly time, and lowers tooling and manufacturing costs.

In addition, the present invention can be applied in direct-lit DMS (Driver Monitoring System) models to meet the demands of emerging technologies such as safe driving system and Level 2 to 5 of autonomous driving. Consequently, its application in Instrument Clusters and Center Information Displays (CIDs) is expected to become increasingly widespread.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A backlight module, comprising:
a back frame;
a light source, comprising a light board disposed on the back frame, and a plurality of light-emitting elements disposed on the light board;
a diffusion plate disposed on the back frame and located on a light-emitting side of the light source; and
a sleeve disposed on the back frame, the sleeve axially penetrating through the light board and the diffusion plate;
wherein a surface of the diffusion plate is provided with a plurality of printed dots, the diffusion plate defining a blank region through which the sleeve passes, and a first region surrounding the blank region,
wherein the first region comprises at least one high-density region and one low-density region,
wherein the blank region is free of printed dots;
wherein a distribution density of the printed dots in the low-density region decreases in a direction extending away from the blank region; and
wherein a distribution density of the printed dots in the at least one high-density region is greater than an average distribution density of the printed dots in the low-density region.

2. The backlight module as claimed in claim 1, wherein the light source comprises a first light region and a second light region in which the light-emitting elements are arranged with different intervals, the light-emitting elements in the first light region being arranged at a first interval in an equidistant manner, and the light-emitting elements in the second light region being arranged at a second interval in an equidistant manner, the first interval is greater than the second interval, and the second light region corresponds to the at least one high-density region of the diffusion plate.

3. The backlight module as claimed in claim 1, wherein the diffusion plate further defines a second region surrounding the first region, and no printed dots are formed in the second region.

4. The backlight module as claimed in claim 1, wherein the back frame comprises a bottom plate portion and a surrounding portion disposed around a periphery of the bottom plate portion, and the sleeve is disposed on the bottom plate portion and extends unidirectionally away from the bottom plate portion.

5. The backlight module as claimed in claim 1, wherein the back frame comprises a bottom plate portion and a surrounding portion disposed around a periphery of the bottom plate portion, and the sleeve is disposed on the bottom plate portion and extends bidirectionally away from the bottom plate portion.

6. The backlight module as claimed in claim 1, wherein an outer surface of the sleeve has a reflectance at least 92%.

7. The backlight module as claimed in claim 1, wherein the printed dots are disposed on a light-incident surface of the diffusion plate, the light-incident surface facing the light board.

8. The backlight module as claimed in claim 1, wherein the sleeve is formed with an internal thread.

9. The backlight module as claimed in claim 1, further comprising a shading member disposed on the sleeve.

10. The backlight module as claimed in claim 1, wherein further comprising a shading member fitted over the sleeve, wherein the shading member comprises a ring portion disposed on the sleeve, a top edge portion extending radially inward from the ring portion and abutting a top edge of the sleeve, and a pressing portion extending radially outward from the ring portion, and the ring portion abuts an outer peripheral surface of the sleeve.

11. The backlight module as claimed in claim 1, further comprising a shading member fitted over the sleeve, wherein the shading member comprises a ring portion disposed on the sleeve, a top edge portion extending radially outward from the ring portion, and a pressing portion extending from the top edge portion, wherein the ring portion abuts an inner peripheral surface of the sleeve, and an end edge of the sleeve is covered collectively by the ring portion, the top edge portion, and the pressing portion.

12. The backlight module as claimed in claim 9, further comprising at least one optical film disposed between the diffusion plate and the shading member, wherein the at least one optical film has a through-hole corresponding to the sleeve.

13. A display device, comprising the backlight module as described in claim 1, and a display panel disposed on the backlight module.

14. A display device, comprising the backlight module as described in claim 9, and a display panel disposed on the backlight module, wherein the display panel rests on the shading member.
